(19) United States
(12) Patent Application Publication
(10) Pub. No.: US 2002/0048659 A1
(43) Pub. Date: Apr. 25, 2002

(54) Recording sheet

(76) Inventors: Yukiko Murasawa, Kanuma-shi (JP); Hideaki Takahashi, Kanuma-shi (JP); Jun Takahashi, Kanuma-shi (JP); Akio Ito, Kanuma-shi (JP)

Correspondence Address: ROSENTHAL & OSHA L.L.P., 700 Louisiana, Suite 4550, Houston, TX, 77002, US

(21) Appl. No.: 09/938,171

(22) Filed: Aug. 23, 2001

(30) Foreign Application Priority Data
Aug. 25, 2000 (JP) 2000-254756

(51) Int. Cl. B41M 5/00

(52) U.S. Cl. 428/195

(57) ABSTRACT

An ink jet recording sheet having high ink-absorbing ability is disclosed. A porous structure is formed inside of an ink-permeable layer of a recording sheet according to the invention. The total volume of pores having a radius ranging between 100 nm or more and 10000 nm or less is 0.06 cm³/g or more owing to the porous structure. Therefore, ink applied to the surface of the ink-permeable layer is permeated vertically through the porous structure and blurring is therefore scarcely caused. Also, an ink-absorbing layer having hydrophilic a resin has high ink-absorbing capacity. The ink permeated through the ink-permeable layer is absorbed in the ink-absorbing layer and fixed, so that it is not diffused in the recording sheet. Therefore, the recording sheet has high ink-absorbing ability and is therefore free from blurring and enables high print density also when it is used for printing in an ink jet system.

### BACKGROUND OF THE INVENTION

1. Field of the invention

The present invention relates to a recording sheet used for recording using ink, and, particularly, to a recording sheet used for printing in an ink jet system.

2. Description of the related art

In recent years, recording of characters, images and the like using an ink jet system has become popular and various ink jet recording sheets have been proposed.

The numeral symbol 110 shown in FIGS. 2a and 2b show an example of such a recording sheet.

The recording sheet 110 is provided with a transparent substrate 111 and an ink receptive layer 112 formed on the surface of the substrate 111. The ink receptive layer 112 is provided with an ink-absorbing layer 113 formed on the substrate 111 and an ink-permeable layer 114 formed on the ink-absorbing layer 113.

When ink jet recordings are made in this recording sheet 110, first, ink is jetted from a nozzle of an ink jet printer towards the surface of the ink-permeable layer 114, where the ink is allowed to permeate through the ink-permeable layer 114 and absorbed in the ink-absorbing layer 113.

A light is applied to the surface (print surface) of the ink receptive layer 112 of the recording sheet 110 to observe from the surface on the side opposite to the print surface. The light transmitted through the portions where the absorbed ink is observed as dots and the aggregate of these dots is recognized as an image (transmitted image).

On the contrary, light may be applied to the surface on the side opposite to the print surface to observe the transmitted image from the print surface.

Such a recording sheet 110 is being used extensively for overhead projectors and illumination advertisements in recent years.

Using prior art systems an unclear image is obtained where blurring in a printed image is caused by the ink receptive layer 112 having insufficient ink-absorbing ability.

### SUMMARY OF THE INVENTION

The present invention provides technologies for producing a recording sheet which has good ink-absorbing ability, has high density of color for the formed printed image and good blurring resistance.

In one respect, the present invention relates to a recording sheet, where the recording sheet comprises a substrate and an ink receptive layer formed on at least one of the surfaces of the substrate, wherein pores are formed on at least the surface portion of the ink receptive layer and the total volume of the pores having a radius of 100 nm or more and 10000 nm or less contained in 1 g of the ink receptive layer is 0.06 cm³ or more.

In another aspect, in the present invention, the ink receptive layer is provided with an ink-absorbing layer formed on the substrate and an ink-permeable layer formed on the surface of the ink-absorbing layer, the ink-permeable layer containing a filler and a binder, wherein the pores are formed in the ink-permeable layer, and the total volume of the pores having a radius of 100 nm or more and 10000 nm or less contained in 1 g of the ink receptive layer is 0.06 cm³ or more.

In another aspect, in the present invention, the binder is added to the ink-permeable layer in an amount ranging from 5 parts by weight to 200 parts by weight on the basis of 100 parts by weight of the filler.

In the recording sheet of the present invention, the ink-absorbing layer contains a hydrophilic resin in an amount ranging from 1% by weight to 100% by weight.

### BRIEF DESCRIPTION OF THE DRAWINGS

FIG. 1(a) to FIG. 1(c) are processing diagram showing a process of producing a recording sheet in accordance with one embodiment of the present invention; and

FIG. 2(a) and FIG. 2(b) are views for explaining a recording sheet in the prior art.

### DETAILED DESCRIPTION

A recording sheet according to one embodiment of the present invention will be explained together with a process of the production of the recording sheet with reference to the drawings.

In a first embodiment, 3.8 parts by weight of polyvinylpyrrolidone, a hydrophilic resin (under the name “Luviskol K-910” manufactured by BASF), 2.5 parts by weight of aluminum hydroxide (under the name “HIGILITE H42” manufactured by Showa Denko K. K.) and 35.6 parts by weight of water were added to 58.3 parts by weight of a water-soluble polyester, a hydrophilic resin (under the name “NS112L” manufactured by TAKAMATSU OIL & FAT CO., LTD). The mixture was dispersed together with glass beads having a diameter of about 1 mm by using a jar mill for 12 hours to prepare a coating solution for an ink-absorbing layer.

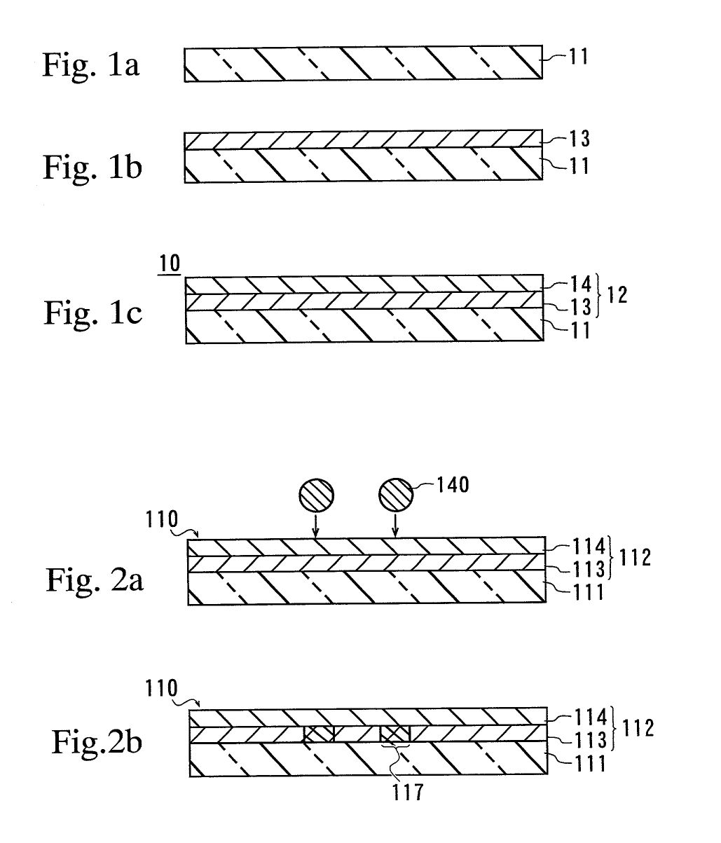

In FIG. 1(a), the numeral symbol 11 represents a transparent substrate (here, a 100 μm thick filmy substrate made of polyethylene terephthalate was used). The coating solution for an ink-absorbing layer which was prepared as described above was applied to the surface of the substrate 11 and thereafter dried under heating at 120° C. for 5 minutes in a drying oven to form an ink-absorbing layer 13 as shown in FIG. 1(b). Here, the ink-absorbing layer 13 having a thickness of 13 μm was formed.

Next, 13.5 parts by weight of a polyester (sold under the name “Vyron 200”, manufactured by Toyobo Co., Ltd) as a binder and 70 parts by weight of a solvent (for the purpose of the embodiment, a solvent was obtained by adding 21 parts by weight of cyclohexane to 49 parts by weight of methyl ethyl ketone) were added to 16.5 parts by weight of silica (sold under the name “Mizukasil P527”, manufactured by MIZUSAWA INDUSTRIAL CHEMICALS.,LTD) as filler. This mixture was then dispersed as in the above method of preparing the coating solution for an ink-absorbing layer, (i.e. using glass beads), to prepare a coating solution for an ink-permeable layer.

Next, the coating solution for an ink-permeable layer was applied to the surface of the ink-absorbing layer 13 as shown in FIG. 1(b) and thereafter dried under heating at 120° C. for 5 minutes in a drying oven to form an ink-permeable layer 14. Here, the ink-permeable layer 14 having a thickness of 15 μm was formed. The numeral symbol 10 in FIG. 1(c) represents a recording sheet which is in the condition that the ink-permeable layer 14 is formed. The ink receptive layer 12 comprising the ink-absorbing layer 13 and the ink-permeable layer 14 is formed on the surface of the recording sheet 10.

The recording sheet 10 was manufactured by the above process as Example 1 and a sample piece having a 2 cm length and 18 cm width rectangular form was cut from the recording sheet of Example 1. The weight of the sample piece was measured using an electronic balance (sold under the name “AEL200”, manufactured by Shimadzu Corporation)and it was 588.96 mg. The weight of the substrate 11 having the same area as the sample piece was measured and it was 493.2 mg. Therefore, the weight of the ink receptive layer 12 of the sample piece was 95.76 mg.

Then, the sample piece was placed in a cell having a volume of 15 cm³ and mercury was powered into the cell under reduced pressure. The cell was then mounted on a porosity measuring meter (sold under the name “Pore Sizer 9320”, manufactured by Micromeritics) to measure the pressure applied to the sample piece and the volume of mercury pressed in the sample piece (mercury intrusion method).

A mercury intrusion curve is found by the pressure and the volume of mercury.

Based on the mercury intrusion curve, the total volume of the pores having a radius ranging from 10 nm or more to less than 10000 nm in the entire sample piece was found. The cumulative specific surface area was determined from the total volume and the radius on the premise that each pore has a cylindrical form. The cumulative specific surface area and the total volume of the pores are respectively divided by the weight(95.76 mg=0.9576 g) of the ink receptive layer 12 of the aforementioned sample piece to find the pore volume(VP:cm³/g) per 1 g of the ink receptive layer and the specific surface area. The results are shown in Table 1 and 2.

TABLE 1
Results of measurements of a pore volume

| | | Range of pore radius (nm) | | | |
|---|---|---|---|---|---|
| | | 10-100 | 100-1000 | 1000-10000 | 100-10000 |
| Example 1 | Pore | 0.006 | 0.160 | 0.006 | 0.166 |
| | volume | | | | |
| | (cm³/g) | | | | |
| Example 2 | Pore | 0.031 | 0.062 | 0.062 | 0.123 |
| | volume | | | | |
| | (cm³/g) | | | | |
| Comparative | Pore | 0.000 | 0.000 | 0.012 | 0. 012 |
| Example 1 | volume | | | | |
| | (cm³/g) | | | | |

TABLE 2
Results of measurements of the specific surface area of a pore

| | | Range of pore radius (nm) | | | |
|---|---|---|---|---|---|
| | | 10-100 | 100-1000 | 1000-10000 | 100-10000 |
| Example 1 | Specific | 0.554 | 1.476 | 0.001 | 1.477 |
| | surface | | | | |
| | area of | | | | |
| | a pore | | | | |
| | (m²/g) | | | | |
| Example 2 | Specific | 1.169 | 0.985 | 0.010 | 0.995 |
| | surface | | | | |
| | area of | | | | |
| | a pore | | | | |
| | (m²/g) | | | | |
| Comparative | Specific | 0.000 | 0.000 | 0.000 | 0.000 |
| Example 1 | surface | | | | |
| | area of | | | | |
| | a pore | | | | |
| | (m²/g) | | | | |

### EXAMPLE

The same filler, binder and solvent that were used in Example 1 were mixed in the same proportion as in Example 1. Using the resulting mixture, a coating solution was prepared for an ink-permeable layer in a method different from the method used in Example 1 for preparing the coating solution for an ink-permeable layer. Here, as the preparation method, a method of dispersing the mixture together with steel balls having a diameter of 2 mm in a jar mill for 5 hours was used.

Using the coating solution for an ink-permeable layer, an ink-permeable layer 14 was formed on the surface of the ink-absorbing layer 13 in the same manner as in Example 1 to obtain a recording sheet 10 of Example 2. The “pore volume” and “specific surface area” of the recording sheet 10 of Example 2 were measured in the same condition as in Example 1. The results of measurements are described in the above Tables 1 and 2.

### COMPARATIVE EXAMPLE

A coating solution for an ink-permeable layer was produced in the same manner as in Example 1 except that a preparation method in which the mixture was dispersed together with steel balls as in Example 2 having a diameter of 2 mm in a jar mill for 48 hours was used, thereby producing a recording sheet of Comparative Example.

The “pore volume” and “specific surface area” of the recording sheet of Comparative Example were measured in the same condition as in Example 1. The results of measurements are described in the above Tables 1 and 2.

As shown in the above Table 1, in the recording sheet 10 obtained in each of Examples 1 and 2, the total volume of pores within the pore radius range from 100 nm or more to less than 10000 nm of the ink receptive layer 12 was 0.06 (cm³/g) or more. On the other hand, in the Comparative Example, the total volume of pores having a radius falling in the same range as above in the ink receptive layer was less than 0.06 (cm³/g).

Also, as shown in the above Table 2, the total of the specific surface area of pores having a radius ranging from 100 to 10000 nm in Examples 1 and 2 was 0.9 (m²/g) or more. In Comparative Example 1, the total of the specific surface area of pores having a radius falling in the same range as above was almost 0.

It was confirmed from these results of measurement that the volume and specific surface area of pores in the entire of the ink receptive layer 12 were changed according to the condition under which the coating solution for an ink-permeable layer was prepared.

Next, using an ink jet printer (sold under the name “MJ-8000C”, manufactured by SEIKO EPSON CORPORATION) charged with pigment type color inks (here, as the pigment type color inks, four color pigment inks, black ink sold under the name “SPC-180K”, cyan ink sold under the name “SPC-180C”, magenta ink sold under the name “SPC-180M” and yellow ink sold under the name “SPC-180Y” manufactured by MIMAKI ENGINEERING. CO., LTD were used), a print image in which white letters were placed on a portion printed over with inks was printed on the recording sheet 10 obtained in each of the above Examples 1 and 2 and Comparative Example.

The print image formed on each of these recording sheets was evaluated for “ink-absorbing ability”, “blurring” and print density” shown below.

### Ink-absorbing Ability

The print image was visually observed to rate the recording sheet as follows: a recording sheet in which the white letters were not seen to be defaced was rated as “good” and a recording sheet in which the white letters were defaced so that these letters could be unrecognized as characters was rated as “poor”.

### Blurring

The recording sheet 10 on which a print image was formed in the above process was placed above a light source of a light box (sold under the name “Fuji Color Light Box 5000 Inverter”, manufactured by Fuji Photo Film Co., Ltd.) with the surface (print surface) on which the ink-permeable layer was formed being made to face downward. The image (transmitted image) projected by the light box was observed visually. Separately, when the surface of the substrate 11 of the recording sheet on the side provided with no ink receptive layer 12 was observed under white light, the image obtained by the reflected light was observed (reflected image).

The case where no blurring was observed in the transmitted image and reflected image was rated as “good” and the case where any blurring was observed in any one of the transmitted image and reflected image was rated as “poor”.

### Print density

The case where the color density of each of “transmitted image” and “reflected image” observed visually in the above condition was sufficiently high was rated as “good” and the case where the color density of any one of these images was low was rated as “poor”.

These results are shown in the following Table 3.

TABLE 3
Evaluation test

| | Ink- | | |
|---|---|---|---|
| | absorbing | | Print |
| | ability | Blurring | density |
| Example 1 | good | good | good |
| Example 2 | good | good | good |
| Comparative | poor | poor | poor |
| Example 1 | | | |

As is clear from the above Table 3, the recording sheet 10 obtained in each of Examples 1 and 2 were evaluated as being superior to the recording sheet obtained in Comparative Example in the results of the evaluation of all of “ink-absorbing ability”, “blurring” and “print density”. The ink receptive layer of the recording sheet of the present invention is formed with pores on the surface portion. Therefore, the ink applied to the surface of the ink receptive layer is allowed to pass through the pores and absorbed in the ink receptive layer.

Also, when the total volume of the pores having a radius ranging from 100 nm to 10000 nm among the pores included in the ink receptive layer is 0.06 cm³/g or more and more preferably 0.1 cm³/g or more, the ink is absorbed rapidly.

In the ink jet system printer, aqueous ink is generally used and a hydrophilic resin is added to the ink-absorbing layer of the present invention. As a result, the ink-absorbing ability of the ink-absorbing layer is high and the ink permeated through the ink-permeable layer is absorbed in the ink-absorbing layer rapidly. Therefore, the ink is not diffused on the interface between the ink-absorbing layer and the ink-permeable layer.

The above explanations are made as to the case where polyethylene terephthalate (PET) is used as the substrate 11. However, the present invention is not limited to this case. As the transparent substrate 11, a glass plate or films made of various other resins may be used.

No limitation is imposed on the type of resin which may be used for the substrate. For example, a polyester, celluloid or polyvinyl chloride may be used and a polyethylene terephthalate (PET) film is preferably used with the view of securing moderate rigidity as above mentioned Examples. Also, there is no limitation to the thickness of the substrate and the thickness is generally 50 to 200 μm.

As the hydrophilic resin which may be used for the ink-absorbing layer 13, for example, an acrylic resin, polyurethane, polyacrylamide, polyvinyl alcohol, gelatin, polyvinyl acetal, starch, polyvinyl butyral, polyvinyl pyrrolidone, water-soluble polyamide or polyvinyl ether besides a polyester used in the above Examples 1 and 2 may be used.

In the above Examples 1 and 2, a polyester is used as the binder of the ink-permeable layer 14. However, the present invention is not limited to this.

Other than such a polyester, for example, polyvinylacetal, epoxy resins, phenoxy resins, acrylic resins, polyamide resins, polyvinyl acetate, polyvinyl alcohol, polyvinyl butyral, styrene-butadiene rubber, polyethylene, polypropylene or ethylene-vinyl acetate copolymers may be used.

Also, although there is no limitation to the thickness of each of the ink-absorbing layer 13 and the ink-permeable layer 14, it is desirable in the present invention that the thickness of the ink-permeable layer 14 be in a range between 1pm or more and less than 50 μm and the thickness of the ink-absorbing layer 13 be in a range between 0.1 μm or more and less than 50 μm.

As methods of forming pores on the surface of the ink receptive layer, it is expressly within the scope of the present invention to use (1) a method in which a foaming agent is contained in the composition of the ink receptive layer and the foaming agent is allowed to foam when the ink receptive layer is formed, (2) a method in which the composition of the ink receptive layer containing two types of solvent having boiling points largely different from each other is applied, followed by drying under heat to vaporize these solvents in order or (3) a method in which an ink-permeable layer containing a filler and a binder is formed on the surface portion of the ink receptive layer. In the present invention, the method (3) is the preferred embodiment because of the strength of pores.

As the filler used for the ink-permeable layer, various materials such as silica, calcium carbonate, glass beads, talc and various resin particles may be used. Various aluminas such as amorphous aluminas and alumina hydrates having a diaspore structure may also be used as the filler. Among these alumina hydrates, those having a boehmite structure or a pseudo boehmite structure have a small particle diameter and are incapable of forming a sufficient porous structure and are not therefore adaptable to the recording sheet of the present invention.

As mentioned above, the recording sheet of the present invention is superior in ink-absorbing ability, so that ink is not diffused in a lateral direction on the surface of the ink receptive layer and therefore the blurring of a print image is scarcely caused and the color density of each of the transmitted image and reflected imaged to be observed is made high.

What is claimed is:

1. A recording sheet comprising:
a substrate; and
an ink receptive layer formed on at least one surface of the substrate, wherein;
pores are formed on at least a surface portion of the ink receptive layer and a total volume of the pores having a radius of 100 nm or more and 10000 nm or less contained in 1 g of the ink receptive layer is 0.06 cm³ or more.

2. A recording sheet according to claim 1, wherein the ink receptive layer is further comprises an ink-absorbing layer formed on the substrate and an ink-permeable layer formed on the surface of the ink-absorbing layer;
the ink-permeable layer containing a filler and a binder, wherein the pores are formed in the ink-permeable layer and the total volume of the pores having a radius of 100 nm or more and 10000 nm or less contained in 1 g of the ink receptive layer and is 0.06 cm³ or more.

3. A recording sheet according to claim 1, wherein the binder is added to the ink-permeable layer in an amount ranging from 5 parts by weight to 200 parts by weight on the basis of 100 parts by weight of the filler.

4. A recording sheet according to claim 2, wherein the binder is added to the ink-permeable layer in an amount ranging from 5 parts by weight to 200 parts by weight on the basis of 100 parts by weight of the filler.

5. A recording sheet according to claim 2, wherein the ink-absorbing layer contains a hydrophilic resin in an amount ranging from 1% by weight to 100% by weight.
